(19) United States
(12) Patent Application Publication
(10) Pub. No.: US 2021/0220806 A1
(43) Pub. Date: Jul. 22, 2021

(54) CATALYST COMPOSITION FOR CONVERSION OF SULFUR TRIOXIDE AND HYDROGEN PRODUCTION PROCESS

(71) Applicants: INDIAN INSTITUTE OF TECHNOLOGY, DELHI, NEW DELHI (IN); ONGC ENERGY CENTRE, NEW DELHI (IN)

(72) Inventors: SREEDEVI UPADHYAYULA, NEW DELHI (IN); ASHOK NIWRITTI BHASKARWAR, NEW DELHI (IN); KISHORE KONDAMUDI, NEW DELHI (IN); PARVATALU DAMARAJU, NEW DELHI (IN); BHARAT BHARGAVA, NEW DELHI (IN); SATINATH BANERJEE, NEW DELHI (IN)

(21) Appl. No.: 16/096,813

(22) PCT Filed: Apr. 27, 2017
(86) PCT No.: PCT/IN2017/050151

§ 371 Date: Oct. 26, 2018

(30) Foreign Application Priority Data
Apr. 28, 2016 (IN) 201611014898

(51) Int. Cl. B01J 27/224; C01B 17/50; B01J 23/86; B01J 6/00; B01J 35/10; B01J 37/02; B01J 37/34; B01J 23/72; B01J 23/745

(52) U.S. Cl. CPC B01J 27/224; C01B 17/502; B01J 23/862; B01J 6/001; B01J 35/1042; B01J 23/745; B01J 23/868; B01J 37/0209; B01J 37/343; B01J 23/72; B01J 35/1038

(57) ABSTRACT

The present disclosure relates to a catalyst composition for conversion of sulphur trioxide to sulphur dioxide and oxygen comprising an active material selected from the group consisting of transitional metal oxide, mixed transitional metal oxide, and combinations thereof; and a support material selected from the group consisting of silica, titania, zirconia, carbides, and combinations thereof. The subject matter also relates to a process for the preparation of the catalyst composition for conversion of sulphur trioxide to sulphur dioxide and oxygen.

### TECHNICAL FIELD

The subject matter described herein in general relates to a catalyst composition for conversion of sulphur trioxide to sulphur dioxide and oxygen comprising an active material selected from the group consisting of transitional metal oxide, mixed transitional metal oxide, and combinations thereof; and a support material selected from the group consisting of silica, Titania, zirconia, carbides, and combinations thereof. The subject matter also relates to a process for the preparation of a catalyst composition for conversion of sulphur trioxide to sulphur dioxide and oxygen.

### BACKGROUND

There are many thermochemical methods available for the production of hydrogen as product and oxygen as by product by splitting water. There are many such thermochemical cycles which have been experimentally analyzed in the last few decades as viable routes. Amongst these cycles, sulphur-iodine thermochemical cycle originally proposed by General Atomic, disclosed in U.S. Pat. No. 4,089,940 is the most promising one due to its higher efficiency. The sulphur-iodine (SI) cycle, produces hydrogen in a series of chemical reactions designed in such a way that the starting material for each is the product of another. In this cycle heat energy enters through several high temperature chemical reactions. Some amount of heat rejected through via exothermic low temperature reaction. The inputs for this reaction are water and high temperature heat and it releases low temperature heat, hydrogen and oxygen. There are no effluents produced in the cycle and all the reagents other than water are recycled and reused. The whole cycles includes the three following reactions as shown below

SO₂(g)+2H₂O (l)+I₂ (l)→H₂SO₄ (aq)+2 HI (aq) (25° C.-120° C.) (1)

2HI (g)→H₂(g)+I₂ (g) (400-700° C.) (2)

H₂SO₄ (g)→H₂O (g)+SO₂ (g)+0.5 O₂ (g) (>800° C.) (3)

The reaction (1) is called the Bunsen reaction, an exothermic gas (SO₂) absorption reaction, which proceeds spontaneously at a temperature range 25° C.-120° C. and produces two acids: HI and H₂SO₄. HI decomposition (2) is slightly endothermic reaction, releases hydrogen and takes place in the temperature range 400-700° C. The decomposition of H₂SO₄ (3) to produce SO₂ is the reaction in two steps. First step includes the thermal decomposition of H₂SO₄ (H₂SO₄→SO₃+H₂O) and the second step is the catalytic decomposition of SO₃ (SO₃→SO₂+½O₂) to SO₂ and oxygen. Lower partial pressure of SO₃ and high temperature favors the decomposition reaction. If the decomposed equilibrium pressure of SO₃ is higher, to increase the decomposition rate of the actual process temperature must be raised. However, catalysts play a major role for improving the dissociation efficiency by lowering the activation energy barrier for the reaction.

U.S. Pat. No. 2,406,930 discloses that sulphuric acid can be thermally decomposed at very high temperatures to get sulphur dioxide and oxygen. U.S. Pat. No. 3,888,730 discloses that sulphuric acid can be decomposed at much lower temperatures provided that the vapours of sulphuric acid are in contact with vanadium catalyst. U.S. Pat. No. 4,089,940 discloses that the decomposition temperature can be further reduced by using platinum catalyst. U.S. Pat. No. 4,314,982 discloses efficient platinum catalyst supported on various supports like barium sulphate, zirconia, titania, silica, zirconium silicate and mixtures thereof. The platinum supported catalysts are stable and effective in the low temperature region of the decomposition reaction, i.e. up to 700° C. At temperatures beyond and above 750° C., copper oxide and iron oxide supported on the above said supports are used as catalyst. Whole catalytic decomposition of acid occurs in series of beds as low temperature bed with supported platinum catalyst and high temperature bed with less expensive iron or copper oxide supported form. The residence times achieved in these beds are 1.0 s and 0.5 s respectively plus or minus 50 percent. The combination of catalysts used for multistage process are capable of carrying out decomposition to SO₂ equal to at least about 95% of the equilibrium value for the optimum temperature at a total residence time of not more than 7 seconds.

KO100860538 discloses copper-iron binary oxide catalysts with or without support on alumina and titania with copper to iron ratio between 0.5 to 2 and catalyst to support as 1:1. The catalysts can withstand high temperatures for long time and higher activity can be maintained up to space velocity of 100-500,000 ml/g catalyst·hr, preferably 500-100,000 ml/g catalyst·hr.

A series of research papers have also been published exploring several catalysts to obtain decomposition of sulphuric acid with high activity and stability. Dokiya et al. [1] in 1977, tested a range of oxide catalyst (TiO₂, V₂O₅, Cr₂O₃, MnO₂, Fe₂O₃, CoO₄, NiO, CuO, ZnO, Al₂O₃ and SiO₂) for sulphuric acid decomposition in the range of 1073-1133 K at atmospheric pressure. Among them, sintered Fe₂O₃ exhibits good catalyst activity, however, the catalyst suffers from loss of activity, surface area and crushing strength at high temperature with time. These observations are based on a 4 h experimental test. Norman et al. [2] in 1982, summarized different active materials on various supports. The active metal/metal oxides they used are Pt, Fe₂O₃, CuO, Cr₂O₃ and supports are Al₂O₃, TiO₂, ZrO₂ & BaSO₄ in various combinations. They concluded that the oxide of chromium and vanadium are volatile and they act as reformation catalyst in the later stage of the reactor. Manganese, cobalt and nickel are shown to have lower activity because of excess sulphation. Platinum and iron (III) oxide were recognized as good active materials and titania as support for the noble metal catalyst. They showed that the platinum with titania support act as good catalyst at lower temperature and Fe₂O₃ and Cr₂O₃ are promising at higher temperature. Ishikawa et al. [3] in 1982, tested Pt, Fe₂O₃, CuO supported on alumina substrate at 1-5% (w/w) loading level and the activity decreased in the order Pt>Fe₂O₃>V₂O₅>CuO. In their experiment, the active material loaded on porous alumina showed four times more activity than the non-porous alumina, but non porous alumina showed better stability. Tagawa et al. [4] in 1989, conducted more systematic study of various inexpensive metallic oxide, of iron, chromium, aluminium, copper, zinc, cobalt, nickel and magnesium. From their experiments, it is found that all catalysts show similar conversions at above 850° C. When operated below 850° C. iron(III) oxide initially shows high conversion and decreases with time due to the formation of sulphate species. The order of activity found to be Pt>Cr₂O₃>Fe₂O₃>CuO>CeO₂>NiO>Al₂O₃.

Barbarossa et al [5] in 2006, carried out experiments with iron oxide loaded on quartz wool and Ag—Pd intermetallic alloy in the temperature range of 500-1100° C. with a residence time of 7 s. Both catalysts have high activity initially and after 16 h of time, iron (III) oxide activity remains constant and loss of activity of Ag—Pd is attributed to the formation of PdO thin film on the surface of the catalyst. Kim et al. [6] in 2006, reported the activity of Fe— catalysts supported on Al or Ti prepared by co-precipitation method. The ratios of Fe— to Al/Ti are 4, 3, 2 and 1. The surface area of the Fe—Al catalyst samples increased significantly with the ratio of Fe— to Al pore volume remaining constant. Fe—Ti catalyst shows higher activity than Fe—Al catalyst at lower temperatures (below 550° C.). Above 800° C., Fe—Al shows the higher activity due to the instability of sulphate. Banejee et al. [7] studied the catalytic activity of iron chromium perovskites [Fe₂₍₁₋ₓ₎Cr₂ₓO₃] for the range of x:{0 to 1}. The catalyst prepared in the solid state route and their surface area found to be in the range of 14-15 m²/g. All the catalysts are tested for 10 h and they found Fe_{1.8}Cr_{0.2}O₃ to be the most active with less sulphate formation. They suggested that low levels of Cr— presence, increase the stability of the catalyst and reduces the formation of stable metal sulphates. Ginosar et al. [8] in 2007, studied the long term stability of the support and catalyst. The catalysts used in this study are platinum and supports are Al₂O₃, TiO₂ and ZrO₂. Titania supported catalyst were found to be stable for long duration of time (240 h) than the rest of the supports. Although titania shows good support, still it lost 8% activity over a period of time (240 h). This is due to lost Pt from the surface as volatile oxides and sintering. Abimanyu et al. in 2008[9], studied the activity of Cu/Al₂O₃, Fe/Al₂O₃ and Cu/Fe/Al₂O₃ composite granule catalysts prepared by oil drop method and gel process. The catalytic activity of Cu/Fe/Al₂O₃ composite is higher than the Cu/Al₂O₃, Fe/Al₂O₃. The catalytic activity increases with increasing the Cu and Fe concentration in the alumina granules and optimum [Cu] to [Fe] ratio found to be 1:2[10]. Karagiannakis et al. [11] synthesised various single and mixed oxide materials for the decomposition of sulphuric acid. These include binary and ternary compositions of the Cu—Fe—Al system as well as Fe—Cr mixed oxide materials prepared by the solution combustion synthesis. The catalysts are tested in the powder form in the fixed bed reactors at 850° C. and ambient pressure. For the Cu—Fe—Al systems, it is found that addition of Cu to Fe-oxide structure enhances the decomposition, whereas addition of both Al and Cu to the Fe-oxide also improves the stability. Banerjee et al. [12] studied the activity of cobalt, nickel and copper ferrospinels for the decomposition of sulphuric acid. These ferrospinels are synthesized by glycine-nitrate gel combustion method. The stoichiometric quantities of starting materials are dissolved in 50 ml of distilled water keeping the fuel-oxidant molar ratio (1:4) so that the ratio of oxidizing to reducing valency is slightly less than unity. The mixed nitrate glycine solution was slowly heated at 150° C., with continuous stirring to remove the excess water. This resulted in the formation of highly viscous gel. Subsequently, the gel was heated at 300° C. which led to auto-ignition with evolution of the undesirable gaseous products, and formation of desired product in the form of foamy powder. The powder is calcined at two different temperatures (500° C. and 900° C.) for 12 hours to obtain crystalline powders of CuFe₂O₄, CoFe₂O₄ and NiFe₂O₄. Copper ferrite is found to be the most active catalyst for the reaction with 78% conversion at 800° C. Zhang et al. [13] prepared composite of oxides i.e. CuCr₂O₄ and CuFe₂O₄ by sol-gel, vacuum freeze-drying (VFD) method and Pt supported on SiC by impregnation method. In the former case they directly used the composite oxides as catalyst, in the latter case support is non porous SiC. It was observed that at temperature below 790° C. Pt/SiC catalyst shown higher activity with yields less than 50% at a space velocity of 50 h⁻¹. At temperatures above 850° C., composite metal oxides have shown around 70% yields. Catalyst stability tests were carried out at a temperature of 850° C. with a space velocity of 50 h⁻¹ for all three catalysts. Among three catalysts, CuFe₂O₄ lost its activity after 45 h of operation, both Pt/SiC and CuCr₂O₄ showed decrease in activity almost 20% of the initial activity after 90 h of operation. Spent catalyst analysis from the stability test shown that three catalysts lost their specific surface area by agglomeration and loss of activity due to the formation of respective sulphates. Even though these catalysts show good activity at high temperatures, lack of good stability in acid media is the main concern. Karagiannakis et al. [14], Giaconia et al. [15] used Fe₂O₃-coated SiSiC honeycombs in which the support has zero porosity and very low surface area (5.32 m²/g). The catalyst is prepared by repetitive slurry impregnation method, to load the iron (III) oxide on the honeycomb. The loaded weight percentage of active metals is in the range 14.9-18.5 w/w %. After calcination at 900° C., the catalyst is powdered and loaded into the reactor. Activity tests of the catalyst were carried out with 96% sulphuric acid as feed in the temperature range 775-900° C., pressure range 1-4 bar and at WHSV 3.2 to 49 h⁻¹ over Fe₂O₃-coated SiSiC honeycombs fragments. This support possesses low surfaces area (5.32 m²/g) with no porosity. It was observed that at optimum operating conditions (WHSV 6.0 h⁻¹ and 17.6 wt % catalyst loading at 850° C. at ˜30% partial pressure of SO₃) catalyst showed around 80% SO₂ conversion and negligible deactivation. Lee et al. [16] studied the decomposition of sulfuric acid over 1 wt % Pt/SiC coated alumina and wt % Pt/Al₂O₃ in the temperature range of 650-850° C. at atmospheric pressure with a GHSV of 72,000 mL/g_{cat}. The catalyst was prepared by dry impregnation method. The Pt/Al₂O₃ catalyst deactivated at 650 and 700° C. due to the formation of aluminium sulphate, but was stable at 750 and 850° C. with highest yield at 60%. The alumina support was coated with SiC by a CVD method with methyltrichlorosilane (MTS) to get a non-corrosive support (SiC—Al) with high surface area. It was observed from the thermal analysis of spent catalyst that coating of SiC on alumina suppressed the formation of sulphates. The conversion of sulfuric acid to SO₂ was about 28%, 48% and 71% at 650, 750 and 850° C., respectively. The decrease in spent catalyst surface area indicates that SiC coating cannot prevent the aluminium sulphate formation completely, although catalyst was stable for 6 h, the authors felt that further improvement of the catalyst is necessary.

Many catalysts are tried in the above process, but metallic oxide catalysts are promising. However, metallic oxide catalysts tend to sinter at high temperatures causing instability to catalyst, which again lowers the activity of the catalyst. Further, using high active platinum catalyst is expensive and a small fluctuation in the process temperature causes the loss of catalyst activity and leaching out from the substrate surface are likely to be disadvantages.

Conventionally used silicon carbide is extremely hard, dark, iridescent crystals devoid of porosity and having very less surface area typically less than 2 m²/g, which is mainly used as an abrasive and as refractory material. It is insoluble in water and inert to acids or alkali up to 800° C. A protective layer of silicon oxide is formed on the surface of silicon carbide when exposed to air at above 1200° C. More recently, U.S. Pat. No. 4,914,070 has reported silicon carbide in the form of porous agglomerates, with specific surface areas of at least about 100 m²/g. Such high surface area silicon and other metallic or metalloid refractory carbide compositions, said to be useful as supports for catalysts for chemical, petroleum and exhaust silencer reactions, and their manufacture, are also described in U.S. Pat. No. 5,217,930[17], U.S. Pat. No. 5,460,759[18], and U.S. Pat. No. 5,427,761[19]. U.S. Pat. No. 6,184,178[20] reports catalyst supports in granular form essentially made up of silicon carbide beta crystallites having specific surface area of at least 5 m²/g, and usually 10-50 m²/g, and with crush resistance of 1-20 MPa according to ASTM D 4179-88a. The supports are said to be useful for chemical and petrochemical catalytic reactions such as hydrogenation, dehydrogenation, isomerization, decyclization, of hydrocarbides, although specific processes and catalyst metals are not described.

Use of high surface area porous β-silicon carbides as supports for catalysts for decomposition of sulfuric acid, more precisely decomposition of sulfur trioxide or for similar reactions at the elevated temperatures and pressures and in the extreme acidic environments of such decomposition processes is not reported in prior art.

### SUMMARY

In an aspect of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

In an aspect of the present disclosure, there is provided a process for producing a catalyst composition including the step of (a) contacting at least one transitional metal salt with a support material selected from the group consisting of silica, titania, zirconia, carbides, and combinations thereof to obtain a transitional metal loaded porous material; (b) calcining the transitional metal loaded porous material at a temperature range of 250-600° C. for a period of 1 to 6 hours and optionally heating at 900 to 1100° C. for 2 to 5 h to obtain a catalyst composition comprising an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

In an aspect of the present disclosure, there is provided a process for producing a catalyst composition including the step of (a) contacting at least one transitional metal salt with a support material selected from the group consisting of silica, titania, zirconia, carbides, and combinations thereof and drying at 50-150° C. for 10 min to 5 h; (b) calcining the transitional metal loaded porous material at a temperature range of 250-600° C. for a period of 1 to 6 h to obtain a partial transitional metal loaded porous material; (c) contacting at least one transitional metal salt with a partial transitional metal loaded porous material and drying at 50-150° C. for 10 min to 5 h to obtain a transitional metal loaded porous material; (d) calcining the transitional metal loaded porous material at a temperature range of 250-600° C. for a period of 1 to 6 hours and optionally heating at 900 to 1100° C. for 2 to 5 h to obtain a catalyst composition comprising an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

These and other features, aspects, and advantages of the present subject matter will be better understood with reference to the following description and appended claims. This summary is provided to introduce a selection of concepts in a simplified form. This summary is not intended to identify key features or essential features of the claimed subject matter, nor is it intended to be used to limit the scope of the claimed subject matter.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1a-c is a graphic representation of HF treatment and oxidation of as-received β-SiC.

FIG. 2 is a graphic representation of FT-IR spectra of (a) as-received β-SiC (β-SiC(R), (b) HF treated β-SiC (β-SiC(P)) and, (c) oxidized β-SiC (β-SiC(PT)) after HF treatment.

### DETAILED DESCRIPTION

Those skilled in the art will be aware that the present disclosure is subject to variations and modifications other than those specifically described. It is to be understood that the present disclosure includes all such variations and modifications. The disclosure also includes all such steps, features, compositions and compounds referred to or indicated in this specification, individually or collectively and any and all combinations of any or more of such steps or features.

### Definitions

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. Throughout this specification, unless the context requires otherwise the word “comprise”, and variations, such as “comprises” and “comprising”, will be understood to imply the inclusion of a stated element or step or group of element or steps but not the exclusion of any other element or step or group of element or steps.

The term “catalyst composite(s)” and “catalyst composition(s)” are used interchangeably in the present disclosure.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited.

The disclosure in general relates to a catalyst composition useful in decomposition of sulphuric acid, more precisely, sulphur trioxide to sulphur dioxide and oxygen in the sulphur-iodine cycle for hydrogen production.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the transitional metal is selected from the group consisting of Cu, Cr, and Fe.

In an embodiment of the present disclosure, there is provided a catalyst composition for conversion of sulphur trioxide to sulphur dioxide and oxygen comprising: an active material comprising of transitional metal oxide selected from the group consisting oxides of Cu, Cr, and Fe; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising of mixed transitional metal oxide selected from the group consisting of binary oxide, a ternary oxide, and a spinel; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising an oxide of Cu; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising an oxide of Cr; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising an oxide of Fe; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising binary oxide of Cu, and Fe in the molar ratio of 1:2; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising an oxide of Cu, and Fe with a spinel structure; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material comprising an oxide of Cu, and Cr with a spinel structure; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the support material has a pore volume in the range of 0.05 to 0.9 cc/g.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the support material has a pore volume in the range of 0.1 to 0.7 cc/g

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the support material has active surface area in the range of 5-35 m²/g.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the support material has specific surface area as determined by BET multipoint nitrogen adsorption method is in the range of 2 to 200 m²/g.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the support material has specific surface area as determined by BET multipoint nitrogen adsorption method is in the range of 5 to m²/g.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the support material has specific surface area as determined by BET multipoint nitrogen adsorption method is in the range of 10 to 60 m²/g.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the catalyst composition has transitional metal content in the range of 0.1 to 20 wt %.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the catalyst composition has transitional metal content in the range of 0.1 to 20 wt %, wherein the catalyst composition has transitional metal content in the range of 2 to 10 wt %

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the active material size is in the range of 0.1 to 15 mm.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %, wherein the active material size is in the range of 0.1 to 25 mm.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material comprising porous β-silicon carbide (β-SiC) or silicated porous silicon carbide (β-SiC(PT)), wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material comprising crystallized porous β-SiC or silicated porous silicon carbide (β-SiC(PT)), wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material comprising crystallized porous β-SiC or silicated porous silicon carbide (β-SiC(PT)) in the form of spheres pellets, extrudates or foam, wherein the active material to the support material weight ratio is in the range of 0.1 to 25 wt %.

In an embodiment of the present disclosure, there is provided a catalyst composition for conversion of sulphur trioxide to sulphur dioxide and oxygen comprising: an active material selected from the group consisting of transitional metal oxide, mixed transitional metal oxide, and combinations thereof; and a support material comprising crystallized porous β-SiC or silicated porous silicon carbide (β-SiC(PT)) in the form of spheres pellets, extrudates or foam, wherein the active material to the support material weight ratio is in the range of 0.1 to 25 wt %, wherein the transitional metal is selected from the group consisting of Cu, Cr, and Fe, wherein the support material has a pore volume in the range of 0.05 to 0.9 cc/g, wherein the support material has active surface area in the range of 5-35 m²/g, wherein the support material has specific surface area as determined by BET multipoint nitrogen adsorption method is in the range of 2 to 200 m² g, wherein the catalyst composition has transitional metal content in the range of 0.1 to 20 wt %.

In an embodiment of the present disclosure, there is provided a catalyst composition comprising transitional metal oxides, i.e., copper and iron oxides in the molar ratio of 1:2 either in bimetallic form or in spinel form or alone employed as a supported catalyst to effectively decompose H₂SO₄ to near equilibrium conversion for wide range of pressures (0.1 to 30 bar) and temperatures (450 to 900° C.). The above mentioned active material supported on silicate crystalline porous β-SiC (β-SiC(PT) surprisingly retains its inertness and structural integrity without any thermal gradients and can be an effective substrate. The substrate or support structure chosen from the group consisting of powders, particles, pellets, granules, spheres, beads, pills, balls, noodles, cylinders, extrudates and trilobes.

When the above said active materials are preferably used as a supported catalyst, the particular support must be able to continue to function when subjected to sulphuric acid vapour atmosphere with sufficient mechanical strength to withstand high pressures and temperatures and permit a high flow rate of reactant and product gases. The most important function of the support is to minimize the rate of growth of migration of crystallites of the active components dispersed on the surface. These are inevitable if the catalysts are operated at high temperature, because caking of support gradually diminishes its role as a dispersant, which adversely affects the activity of the catalyst. Additionally, it is also important that the catalyst support must be inert, and capable of retaining its mechanical strength, structural integrity in the corrosive sulphuric acid vapour environment along with good thermal stability at the temperature and pressure range of the reaction.

It has been found that a number of usual oxide support materials such as alumina, titania employed in catalyst systems do not exhibit a commercially practical life between 450° C. to 950° C. and in the environment and thus are not considered suitable. Moreover, operation at lower end of the temperature range is often particularly detrimental to the substrate and operating at higher end is dangerous for the active metallic oxides due to sintering. However, it has been found that loading of active material on pretreated porous β-SiC or silicated porous β-SiC (β-SiC(PT)) exhibits good stability, inertness and effectiveness. Moreover, the catalyst is more economical and there will be few thermal gradients within the economical operational range.

Maximizing the surface area is very important in a catalytic reaction such as this. In an embodiment of the present disclosure, there is provided a catalyst composition for conversion of sulphur trioxide to sulphur dioxide and oxygen comprising iron and copper oxide mixture in the form of bimetallic oxide mixture is dispersed upon the support in an amount less than about 25 w/w (weight percent).

In an embodiment of the present disclosure, there is provided a catalyst composition for conversion of sulphur trioxide to sulphur dioxide and oxygen comprising iron and copper oxide mixture in the spinel form is dispersed upon the support in an amount between 3-10% (weight percent) based on the support weight. At a level of 8% of the active copper-iron spinel (weight percent based on the support weight), the surface area of the catalyst would be at least 10 m²/g of the catalyst.

The catalyst composition can be employed in a fixed bed, or a part of the single bed either in single stage or multistage operation or in dynamic bed, e.g. moving bed/fluidized bed using any form of the catalyst. The sulphuric acid vapour passed through the bed can be maintained at desired range (600 to 1000° C.), more preferably at 850° C.

The support structures of these catalysts are in the form of divided or discrete structures or particulates. The terms “distinct” or “discrete” structures or particulates, as used herein, refer to support in the form of divided materials such as granules, beads, pills, pellets, cylinders, trilobes, extrudates, spheres or other rounded shapes, or another manufactured configuration. Alternatively, the divided material may be in the form of irregularly shaped particles. Preferably, at least a majority (i.e., >5%) of the particles or distinct structures have a maximum characteristic length (i.e., longest dimension) of less than 25 millimeters, preferably less than six millimeters. According to some embodiments, the divided catalyst structures have a diameter or longest characteristic dimension of about 0.25 mm to about 6.4 mm (about 1/100″ to about ¼″), preferably, between about 0.5 mm and about 4.0 mm. In other embodiments they are in the range of about 50 microns to 6 mm.

The present disclosure also relates to a process for producing a stable and economical catalyst for the decomposition of sulphuric acid in the sulphur-iodine cycle. In an embodiment of the present disclosure, there is provided a process for producing a catalyst composition including the step of (a) contacting at least one transitional metal salt with a support material selected from the group consisting of silica, titania, zirconia, carbides, and combinations thereof to obtain a transitional metal loaded porous material; (b) calcining the transitional metal loaded porous material at a temperature range of 250-600° C. for a period of 1 to 6 hours and optionally heating at 900 to 1100° C. for 2 to 5 h to obtain a catalyst composition comprising an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a process for producing a catalyst composition, wherein the support material is contacted with an aqueous solution of the at least one transitional metal salt and homogenized to obtain transitional metal loaded porous material.

In an embodiment of the present disclosure, there is provided a process for producing a catalyst composition, wherein the support material is contacted with an aqueous solution of the at least one transitional metal salt in parts and homogenized by sonication to obtain transitional metal loaded porous material.

In an embodiment of the present disclosure, there is provided a process for producing a catalyst composition, wherein the support material is contacted with an aqueous solution of the at least one transitional metal salt, homogenized by sonication for 10 min to 1 h, and dried at 50-150° C. for 10 min to 5 h to obtain transitional metal loaded porous material.

In an embodiment of the present disclosure, there is provided a process for producing a catalyst composition, wherein the transitional metal loaded porous material is air dried at 50-150° C. for 10 min to 5 h before calcination.

In an embodiment of the present disclosure, there is provided a process for producing a catalyst composition, the process comprising; contacting at least one transitional metal salt with a support material selected from the group consisting of silica, titania, zirconia, carbides, and combinations thereof to obtain a partial transitional metal loaded porous material; drying the partial transitional metal loaded porous material at 50-150° C. for 10 min to 5 h, contacting at least one transitional metal salt with a partial transitional metal loaded porous material to obtain a transitional metal loaded porous material; calcining the transitional metal loaded porous material at a temperature range of 250-600° C. for a period of 1 to 6 hours and optionally heating at 900 to 1100° C. for 2 to 5 h to obtain a catalyst composition comprising an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

In an embodiment of the present disclosure, there is provided a process for producing a catalyst composition, wherein the support material is contacted with an aqueous solution of the at least one transitional metal salt and homogenized to obtain partial transitional metal loaded porous material.

In an embodiment of the present disclosure, there is provided a process for producing a catalyst composition, wherein the partial transitional metal loaded porous material is contacted with an aqueous solution of the at least one transitional metal salt and homogenized to obtain the transitional metal loaded porous material.

In an embodiment of the present disclosure, there is provided a process for producing a catalyst composition, wherein the support material is contacted with an aqueous solution of the at least one transitional metal salt in parts and homogenized by sonication to obtain partial transitional metal loaded porous material.

In an embodiment of the present disclosure, there is provided a process for producing a catalyst composition, wherein the partial transitional metal loaded porous material is contacted with an aqueous solution of the at least one transitional metal salt in parts and homogenized by sonication to obtain transitional metal loaded porous material.

In an embodiment of the present disclosure, there is provided a process for producing a catalyst composition, wherein the support material is contacted with an aqueous solution of the at least one transitional metal salt, homogenized by sonication for 10 min to 1 h, and dried at 50-150° C. for 10 min to 5 h to obtain partial transitional metal loaded porous material.

In an embodiment of the present disclosure, there is provided a process for producing a catalyst composition, wherein the partial transitional metal loaded porous material is contacted with an aqueous solution of the at least one transitional metal salt, homogenized by sonication for 10 min to 1 h, and dried at 50-150° C. for 10 min to 5 h to obtain transitional metal loaded porous material.

In an embodiment of the present disclosure, there is provided a process for producing a catalyst composition, wherein the at least one transitional metal salts are salts of transitional metals selected from the group consisting of Cu, Cr, and Fe. salts of Ni are selected from the group consisting of nickel nitrate, nickel chloride, nickel formate, nickel acetate and nickel carbonate.

In an embodiment of the present disclosure, there is provided a process for producing a catalyst composition, wherein the at least one transitional metal salts of Cu, Cr, and Fe are selected from the group consisting of citrate, nitrate, chloride, formate, acetate and carbonate.

In an embodiment of the present disclosure, there is provided a process for producing a catalyst composition, wherein the support material has a pore volume in the range of 0.1 to 0.7 cc/g.

In an embodiment of the present disclosure, there is provided a process for producing a catalyst composition, wherein the support material has active surface area in the range of 5-35 m²/g.

In an embodiment of the present disclosure, there is provided a process for producing a catalyst composition, wherein the support material is porous β-silicon carbide (SiC) or silicated porous β-silicon carbide (β-SiC) (i.e. β-SiC(PT)).

In an embodiment of the present disclosure, there is provided a process for producing a catalyst composition, wherein the support material is crystallized porous β-SiC or silicated porous β-silicon carbide (β-SiC) (i.e. β-SiC(PT)).

The catalyst composition can be manufactured or synthesized in variety of ways i.e. by deposition, precipitation, impregnation, spray drying, or by solid state route or combination of therein. For example, the impregnation can be performed in the following manner. A measured volume of solution containing a calculated quantity of precursor of respective element compound can be added to about the same volume or in excess to the catalyst support having a particle size of 0.5-10 mm. In one embodiment, the catalyst support can have a particle size of 1-5 mm. After standing 2 hours with intermediate agitations, the solvent can be evaporated, dried at 343 K-393 K and calcined in the air for 2 hours to 5 hours at 550° C. The catalyst obtained by the above process is metallic oxide supported on β-SiC with a surface area not less than 10 m²/g. To prepare copper ferrite, respective metallic precursor can be impregnated in the required molar ratio (Fe:Cu=1:2) separately or sequentially as per the above said procedure. After the calcination, temperature adjusted between 1223 K-1273 K for a period of 2-5 hours to complete the reaction between iron oxide and copper oxide to form copper ferrite (CuFe₂O₄). The quantity of elements contained in these catalysts is determined by atomic absorption spectroscopy (AAS) after mineralization of the samples. All are indicated by weight % with respect to the substrate.

Most of the known metal oxide catalysts are active at high temperature and cause sintering and after prolonged period of activity. The catalyst prepared according to the present invention is excellent in the activity and stability when tested for a long time in the temperature ranges of 873 K-1473 K more preferably between 973 K-1173 K and pressure ranges of 0.1-30 bar more preferably between 1-20 bar for the decomposition of sulphuric acid and more precisely SO₃ conversion to SO₂ and O₂ in the sulphur-iodine cycle. According to the present invention, the space velocities of sulphuric acid at atmospheric conditions in the reactor is maintained anywhere between (100-500,000) ml/g-catalyst-hr., preferably 500-72,000 ml/g·cat-hr. are suitable. All experiments are carried out in the presence of inert gas of nitrogen.

Although the subject matter has been described in considerable detail with reference to certain embodiments thereof, other embodiments are possible.

### EXAMPLES

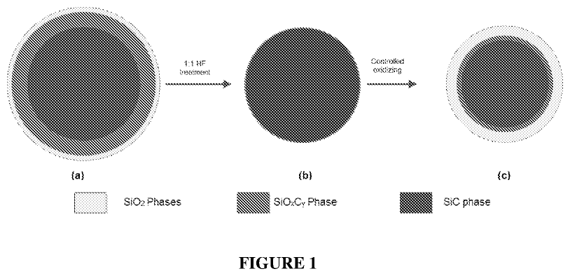

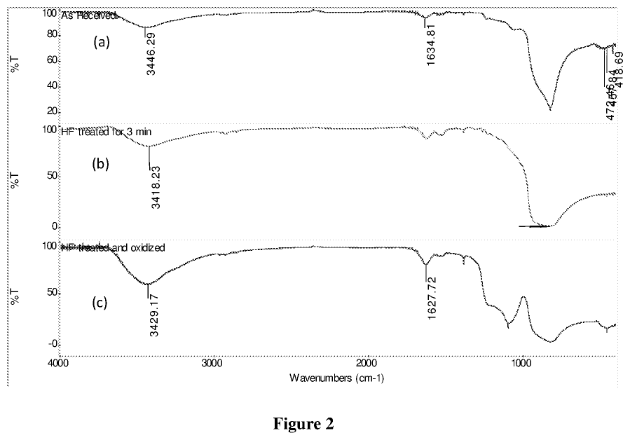

The following examples are given by way of illustration of the present invention and should not be construed to limit the scope of present disclosure. It is to be understood that both the foregoing general description and the following detailed description are exemplary and explanatory only and are intended to provide further explanation of the claimed subject matter. SiC obtained from SICAT (β-SiC(R) as-received), consists optically distinct phases. The grains of the SiC powder contain a minor quantity of amorphous silica at outer layer, an anisotropic SiOₓC_{y} layer is sandwiched between bulk SiC superficial surface layer and outer SiO₂ layer as depicted in FIG. 1(a). FT-IR spectra of as received SiC (β-SiC(R), shown in FIG. 2(a) reveals the vibrational bands at 820-830 cm⁻¹ which corresponds to the bulk SiC layer, vibrational bands at 900 and 1164 cm⁻¹ are attributed to crystalline SiOₓC_{y} phases, and bands around 1200 cm⁻¹ corresponds to amorphous silica. The absence of vibrational bands in the range of 1080-1110 cm⁻¹ in as-received SiC (β-SiC(R)) shows that surface is predominantly SiOₓC_{y} layers than the SiO₂ layer. When as-received SiC is treated with HF (1:1 diluted with water) for 3 to 5 min under sonication and subsequently washing with plenty of water leads to dissolution of SiOₓC_{y}/SiO₂ phases and leaving pure SiC phase (here onwards β-SiC(P)) (as shown in the FIG. 1(b)), which is also evident from the absence of peaks at 1066 to 1164, 1228 cm⁻¹ in the FIG. 2(b). When HF etched samples are further oxidized in atmospheric air in the temperature range of 500-750° C. for a period of 2-6 h, the superficial layers of SiC are oxidized to form SiOₓC_{y}/SiO₂ layers with predominantly amorphous SiO₂ layer as shown in FIG. 1(c) (here onwards β-SiC(PT)). FT-IR spectra of oxidized samples in FIG. 2(c) shows that the very strong and broad IR band at 1098 cm⁻¹ with a shoulder at 1216 cm⁻¹ is usually assigned to the TO and LO modes of the Si—O—Si asymmetric stretching vibrations. The IR band at 900-950 cm⁻¹ can be assigned to silanol groups/Si—O-stretching vibrations. The IR band at around 800 cm⁻¹ can be assigned to Si—O—Si symmetric stretching vibrations, whereas the IR band around 460-480 cm⁻¹ is due to O—Si—O bending vibrations. The stronger absorption band around 820-830 cm⁻¹ is assigned to bulk SiC. The oxidized form of SiC process high amount of amorphous layer of SiO₂, which have better support and catalyst interaction than the as-received SiC.

### Example 1(a)

### Pre-Treatment of Catalyst Support

A catalyst support was obtained by using a synthesis method termed the pre-treatment method (PTM). Silicon carbide (β-SiC) extrudates (2 mm diameter) were supplied by SICAT Sarl(France) and here onwards noted as β-SiC(R) or β-SiC as received. β-SiC(R) samples were etched with a 1:1 HF solution in water for 3-5 minutes under sonication at room temperature in order to remove SiOₓC_{y}/SiO_{z} from the surface of the β-SiC. The samples were filtered and washed with plenty of deionized water until the filtrate pH value reached between 6.5 to 7 and then sample were dried at 120° C. under vacuum for 3 to 5 h, here onwards noted as β-SiC(P) or simply silica free β-SiC. Subsequently dried sample (β-SiC(P)) was oxidized in atmospheric air between 700-1000° C. for a period of 2-6 h to obtain the pre-treated β-SiC or simply β-SiC(PT).

### Example 1(b)

Preparation of a Catalyst Fe₂O₃/β-SiC(R) (for comparison)

1.713 g of Iron precursor (ammonium iron citrate) dissolved in 10 ml of distilled water and then to 10 g of pre dried and degassed β-SiC(R) extrudates of 2 mm size were added. Then, the resulting mixture was sonicated for about 30 min such that whole β-SiC(R) completely dipped into the solution. After half an hour β-SiC(R) was separated from the solution and dried at 80° C. for 30 min and then again added to the remaining solution, so that the whole iron solution was absorbed by β-SiC(R). Finally, the impregnated substrate was air dried at 100° C. for 1 h and then calcined at 500° C. for 2 h. The final catalyst is 5% Fe₂O₃ supported on β-SiC(R). 2 to 15% (w/w) of supported iron oxide catalysts were also prepared by similar approach.

### Example 1(c)

Preparation of a Catalyst Fe₂O₃/β-SiC(P)

Fe₂O₃ supported β-SiC(P) was prepared with same protocol used in Example 1(b), where β-SiC(P) support was used in the place of β-SiC(R) support in the example.

### Example 1(d)

Preparation of a Catalyst Fe₂O₃/β-SiC(PT) (for Comparison)

Fe₂O₃ supported β-SiC(PT) was prepared with same protocol used in the Example 1(b), where β-SiC(PT) support used in the place of β-SiC(R) support.

### Example 2(a)

Preparation of a Catalyst Cu₂O/β-SiC(R) (for comparison)

1.8741 g of copper precursor (Cu(NO₃)₂.3H₂O) dissolved in 10 ml of distilled water and then to 10 g of pre dried and degassed β-SiC(R) extrudates of 2 mm size were added. Then, the resulting mixture was sonicated for about 30 min such that whole β-SiC(R) completely dipped into the solution. After half an hour β-SiC(R) is separated from the solution and dried at 80° C. for 30 min and then again added to the remaining solution, so that the whole copper solution was absorbed by β-SiC(R). Finally, the impregnated substrate was air dried at 100° C. for 1 h and then calcined at 500° C. for 2 h. The final catalyst is 5% Cu₂O supported on β-SiC(R). 2 to 15% (w/w) of supported copper(I) oxide catalysts were also prepared by similar approach.

### Example 2(b)

Preparation of a Catalyst Cu₂O/β-SiC(PT) (for comparison)

5% Cu₂O/β-SiC(PT) catalyst was prepared with same protocol used in Example 1(b), where β-SiC(PT) support used in the place of β-SiC(R) support in the example. Using similar approach 2 to 15% (w/w) of supported copper(I) oxide catalysts over β-SiC(PT) support were also prepared.

### Example 3(a)

Preparation of a Catalyst Cr₂O₃/β-SiC(R) (for comparison) 1.101 g of Ammonium chromate (Cu(NO₃)₂.3H₂O) dissolved in 10 ml of distilled water and then to 10 g of pre dried and degassed β-SiC(R) extrudates of 2 mm size were added. Then, the resulting mixture was sonicated for about 30 min such that whole β-SiC(R) completely dipped into the solution. After half an hour β-SiC(R) was separated from the solution and dried at 80° C. for 30 min and then again added to the remaining solution, so that the whole ammonium chromate solution was absorbed by β-SiC(R). Finally, the impregnated substrate was air dried at 100° C. for 1 h and then calcined at 500° C. for 2 h. The final catalyst was 5% Cr₂O₃ supported on β-SiC(R). 2 to 15% (w/w) of supported chromium (III) oxide catalysts over β-SiC(R) support were also prepared by similar approach.

### Example 3(b)

Preparation of a Catalyst Cr₂O₃/β-SiC(PT) (for comparison)

5% Cr₂O₃/β-SiC(PT) catalyst was prepared with same protocol used in Example 3(a), where β-SiC(PT) support used in the place of β-SiC(R) support. Using similar approach 2 to 15% (w/w) of supported Cr₂O₃ catalysts supported over β-SiC(PT) were also are prepared.

### Example 4(a)

Preparation of a Catalyst CuFe₂O₄/β-SiC(R)

1.176 g of ammonium nitrate (Fe(NO₃).9H₂O) and 0.5049 g of copper nitrate (Cu(NO₃)₂.3H₂O) dissolved in 15 ml of distilled water and then to 10 g of pre dried and degassed β-SiC(R) extrudates of 2 mm diameter were added. Then the resulting mixture was sonicated for about 30 min such that whole β-SiC(R) completely dipped into the solution. After half an hour β-SiC was separated from the solution and dried at 80° C. for 30 min and then again added to the remaining solution, so that the whole solution was absorbed by β-SiC(R). Finally, the impregnated substrate was air dried at 100° C. for 1 h and then calcined at 500° C. for 2 hrs. Then, the temperature of the furnace was gradually raised to 1000° C. and kept at 1000° C. for 3 h with intermediate mixing of solids. The obtained catalyst was 5% CuFe₂O₄ supported on β-SiC(R) catalyst.

### Example 4(b)

Preparation of a Catalyst CuFe₂O₄/β-SiC(P)

5% CuFe₂O₄/β-SiC(P) catalyst was prepared using the same protocol as used in the example 4(a), where β-SiC(P) was used as support instead of β-SiC(R) in the example. 2 to 15% (w/w) of CuFe₂O₄/β-SiC(P) catalysts were also prepared by similar approach.

### Example 4(c)

Preparation of a Catalyst CuFe₂O₄/β-SiC(PT)

5% CuFe₂O₄/β-SiC(PT) catalyst was prepared using the same protocol as used in the example 4(a), where β-SiC(PT) was used as support instead of β-SiC(R). 2 to 15% (w/w) of CuFe₂O₄/β-SiC(PT) catalysts were prepared by similar approach.

### Example 5(a)

Preparation of a Catalyst CuCr₂O₄/β-SiC(R)

An aqueous solution of chromium anhydride and copper nitrate were impregnated using the pore volume method or dry impregnation method into the β-SiC(R). In this method, 6 ml aqueous solution of chromium anhydride and copper nitrate (stoichiometric proportional) were added to 10 g of β-SiC(R) and then the solid was left to mature for 12 hours. The solid was then oven dried at 120° C. for twelve hours, and calcined for three hours at 900° C. in a stream of dry air (1 l/h·g of catalyst) to obtain the CuCr₂O₄/β-SiC(R).

### Example 5(b)

Preparation of a Catalyst CuCr₂O₄/β-SiC(PT)

CuCr₂O₄/β-SiC(PT) catalyst was prepared using the same protocol as used in the example 5(a), where β-SiC(PT) was used as support instead of β-SiC(R). 2 to 15% (w/w) of CuCr₂O₄/β-SiC (PT) catalysts were prepared by similar approach.

### Example 6(a)

Preparation of a Catalyst FeCr₂O₄/β-SiC(R)

An aqueous solution of chromium anhydride and iron nitrate were impregnated using the pore volume method or dry impregnation method into the β-SiC(R). In this method, 6 ml aqueous solution of chromium anhydride and iron nitrate (stoichiometric proportional) were added to 10 g of β-SiC(R) and then the solid was left to mature for 12 hours. The solid was then oven dried at 120° C. for twelve hours, and calcined for three hours at 900° C. in a stream of dry air (1 l/h·g of catalyst) to obtain the FeCr₂O₄/β-SiC(R).

### Example 6(b)

Preparation of a Catalyst FeCr₂O₄/β-SiC(PT)

FeCr₂O₄/β-SiC(PT) catalyst was prepared using the same protocol as used in the example 6(a), where β-SiC(PT) was used as support instead of β-SiC(R).

### Example 7

Preparation of a Catalyst CuFe₂O₄/Al₂O₃

1.176 g of ammonium nitrate (Fe(NO₃).9H₂O) and 0.5049 g of copper nitrate (Cu(NO₃)₂.3H₂O) dissolved in 15 ml of distilled water and then to 10 g of pre dried and degassed alumina extrudates of 1 mm diameter were added. Then the resulting mixture was sonicated for about 30 min such that whole alumina completely dipped into the solution. After half an hour alumina was separated from the solution and dried at 80° C. for 30 min and then again added to the remaining solution, so that the whole solution was absorbed by alumina. Finally, the impregnated substrate was air dried at 100° C. for 1 h and then calcined at 500° C. for 2 hrs. Then the resulting calcined material temperature was raised to 1000° C. gradually and heated for 3 h with intermediate mixing. The obtained catalyst was 5% CuFe₂O₄ supported on Alumina (Al₂O₃) catalyst.

### Example 8

Preparation of a Catalyst Fe₂O₃/Al₂O₃

1.713 g of Iron precursor (ammonium iron citrate) dissolved in 10 ml of distilled water and then to 10 g of pre dried and degassed alumina extrudates of 1 mm diameter were added. Then, the resulting mixture was sonicated for about 30 min such that whole alumina completely dipped into the solution. After half an hour alumina extrudates were separated from the solution and dried at 80° C. for 30 min and then again added to the remaining solution, so that the whole iron solution was absorbed by alumina extrudates. Finally, the impregnated substrate was air dried at 100° C. for 1 h and then calcined at 500° C. for 2 h. The final catalyst was 5% Fe₂O₃ supported on Al₂O₃. 2 to 15% (w/w) of supported iron oxide and copper oxide catalysts supported over alumina were also prepared by similar approach.

### Example 9(a)

Preparation of CoFe₂O₄ Catalyst.

In a typical procedure 0.20M Fe(NO₃)₃ solution was mixed together with 0.10M Co(NO₃)₂ solution. Then, an appropriate amount of a 6M NaOH solution was added to the mixed solution to adjust the pH to 8-14 and de-ionized water was added to the resulting solution until the volume of the solution was about 160 ml. The mixture was stirred strongly for 30 minute and then transferred into a 300 ml Teflon-lined autoclave. The autoclave was sealed and maintained at 200° C. for 48 h. After the reaction was completed, the resulting solid product was filtered and washed with water and absolute alcohol several times. Finally the filtered sample was dried 120° C. for 4 h to obtain the CoFe₂O₄ spinel catalyst.

### Example 9(b)

Preparation of a Catalyst CoFe₂O₄/β-SiC (PT).

1.135 g ammonium ferric citrate was dissolved in 10 ml distilled water and 10 g of pre dried and degassed β-SiC(PT) extrudates of 2 mm diameter were added. Then the resulting mixture was sonicated for about 30 min such that whole β-SiC (PT) completely dipped into the solution. After half an hour β-SiC extrudates were separated from the solution and dried at 80° C. for 30 min and then again added to the remaining solution, so that the whole solution is absorbed by β-SiC(PT). Then the sample was dried for 5 h in air and calcined at 400° C. in furnace for 3 h. Then again sample was removed from the furnace and cooled to room temperature for sub sequent impregnation with the 10 ml cobalt nitrate solution (0.619 g of Co(NO₃)₂.6H₂O in 10 ml water). Again same procedure was repeated and calcined at 900° C. temperature for 3 h and after furnace temperature was gradually raised to 1000° C. for completion of solid state reaction for 4 h. The resulting catalyst was noted as CoFe₂O₄/β-SiC(PT).

### Example 10(a)

Preparation of NiFe₂O₄ Catalyst

NiFe₂O₄ catalyst was prepared by hydrothermally by mixing equal volumes of Ni(NO₃)₂.6H₂O and Fe(NO₃)₃.9H₂O solutions in the molar ration of 1:2 (i.e. 0.10M, 0.2M respectively). A solution of 6M NaOH was added to the mixed salt solution by drop-wise until the final pH value attained a designated value to form an admixture. The admixture was transferred into a Teflon autoclave (300 ml) with a stainless steel shell, and a little de-ionized water was added into the Teflon autoclave up to 80% of the total volume. The autoclave was heated to 200° C. for 48 h and allowed to cool to room temperature naturally. The final product was filtered and washed with de-ionized water and pure alcohol for several times to remove possible residues and then dried at 120° C. for 4 h to obtain NiFe₂O₄ catalyst

### Example 10(b)

Preparation of NiFe₂O₄/β-SiC(PT) Catalyst

Ammonium iron citrate (1.135 g in 10 ml) and nickel nitrate solution (0.619 g Ni(NO₃)₂.6H₂O in 10 ml water) were sequentially deposited one by one as given in the example 9(b) on β-SiC(PT) extrudates. After calcination in air samples temperature was kept at 900° C. for completion of solid state reaction between Nickel and iron(III) oxides to from nickel ferrite crystal of the support. Thus the catalyst formed was noted as NiFe₂O₄ supported over β-SiC(PT).

### Example 11(a)

Preparation of ZnFe₂O₄ Catalyst

ZnFe₂O₄ spinel were prepared by using the hydrothermal method in which stoichiometric amounts of zinc and iron nitrates were dissolved in deionized water. Then an appropriate amount 6M NaOH solution was added to the salt solution to adjust the pH=10-12. Then the resulting mixture was transferred into a Teflon stainless steel autoclave and temperature was maintained at 200° C. for 24 h. After the reaction was completed, the resulting solid product was filtered and washed with plenty of water and alcohol several times. Finally filtered sample was air dried at 120° C. for 4 h to obtain the ZnFe₂O₄ spinel catalyst.

### Example 11(b)

Preparation of ZnFe₂O₄/β-SiC(PT) Catalyst

10 ml of ammonium ferric citrate (0.1104M) was added to 10 g of β-SiC(PT) extrudates. Then the resulting mixture was shaken for few minutes such that the whole Ceramic just dipped into the solution and left for half an hour. After that silicon carbide extrudates were separated from the remaining solution and dried at 80° C. in oven for 2 h and then again added to the remaining solution so that the whole iron solution is absorbed by β-SiC(PT) extrudates. The impregnated supported catalyst was first dried at 100° C. for two hours and calcined at 400° C. in muffle furnace for 3 h and cooled to room temperature. Again same procedure was repeteated with 10 ml zinc nitrate solution (0.615 g in 10 ml water). Finally catalyst was calcined at 900° C. for 2 h and then temperature gradually increased to 1000° C. in furnace for 3 h to complete final solid state reaction to obtain ZnFe₂O₄ supported over β-SiC(PT).

### Example 12(a)

Preparation of a Catalyst NiCr₂O₄

NiCr₂O₄ catalysts were synthesized via solid state route using NiO and α-Cr₂O₃ as starting materials. 1:1 molar mixture of NiO and α-Cr₂O₃ samples were thoroughly mixed using mortar and pestle and heated to 650° C. 6 h and then gradually heated to 900° C. in 12 h to complete the homogeneous reaction between the two oxides with intermediate mixing. Finally the samples were further kept 900° C. for 5 h to obtain the NiCr₂O₄ catalyst.

### Example 12(b)

Preparation of a Catalyst NiCr₂O₄/β-SiC(PT)

An aqueous solution of chromium anhydride and nickel nitrate were impregnated using the pore volume method or dry impregnation method into the β-SiC(PT). In this method, 6 ml aqueous solution of chromium anhydride and nickel nitrate (stoichiometric proportional) were added to 10 g of β-SiC(PT) and then the solid was left to mature for 12 hours. The solid was then oven dried at 120° C. for twelve hours, and calcined for three hours at 900° C. in a stream of dry air (1 l/h·g of catalyst) to obtain the NiCr₂O₄/β-SiC(PT).

### Example 13(a)

Preparation of a Catalyst ZnCr₂O₄

0.025 mole of Zn(NO₃)₂.6H₂O and 0.05 mole of Cr(NO₃)₃.9H₂O was dissolved in 90 ml distilled water to form a clear aqueous solution. 4M NaOH solution was slowly dropped into the aqueous solution vigorously stirred to adjust the pH 7-12 to obtain the suspension. The obtained suspension was transferred into Teflon-lined 300 ml capacity autoclave and heated to 200° C. for 48 h. Then the product was filtered and washed with plenty of deionised water and alcohol. Then the washed product was dried at 120° C. for 4 h to obtain the green powder(ZnCr₂O₄).

### Example 13(b)

Preparation of ZnCr₂O₄/β-SiC(PT) Catalyst

An aqueous solution of chromium anhydride and nickel Zinc nitrate were impregnated using the pore volume method or dry impregnation method into the β-SiC(PT). In this method, 6 ml aqueous solution of chromium anhydride and zinc nitrate (stoichiometric proportional) were added to 10 g of β-SiC(PT) and then the solid was left to mature for 12 hours. The solid was then oven dried at 120° C. for twelve hours, and calcined for three hours at 900° C. in a stream of dry air (1 l/h·g of catalyst) to obtain the ZnCr₂O₄/β-SiC(PT).

### Example 14

Preparation of Cr₂O₃ catalyst

Chromium (III) oxide catalyst was prepared by mixing the chromium sulphate with 3% wt % polyvinyl alcohol and was made into spherical pellets. These pellets were calcined at 1000° C. for 5 h in air to decompose into chromium oxide.

### Example 15

### Preparation of Cu₂O Catalyst

Cuprous oxide was prepared by mixing the copper sulphate with 3% wt % polyvinyl alcohol and was made into spherical pellets. These pellets were calcined at 1000° C. for 5 h in air to decompose into Copper (I) oxide.

### Example 16(a)

Preparation of a Catalyst Pt/Al₂O₃.

An aqueous solution of chloroplatinic acid was impregnated using the pore volume method or dry impregnation method into the Alumina (Al₂O₃). The platinum (Pt) concentration in the solution was calculated to obtain the desired Pt content on the support, then the solid was left to mature for 12 hours. The solid was then oven dried at 120° C. for twelve hours, and calcined for three hours at 500° C. in a stream of dry air (1 l/h·g of catalyst) and reduced at 350° C. in stream of 10% hydrogen gas in Nitrogen (1 l/h·g of catalyst) for 3 h to obtain the 1% Pt/Al₂O₃.

### Example 16(b)

### Preparation of a Catalyst Pt/β-SiC(PT)

An aqueous solution of chloroplatinic acid was impregnated using the pore volume method or dry impregnation method into the silicon carbide (β-SiC(PT)). The platinum (Pt) concentration in the solution was calculated to obtain the desired Pt content on the support, then the solid was left to mature for 12 hours. The solid was then oven dried at 120° C. for twelve hours, and calcined for three hours at 500° C. in a stream of dry air (1 l/h·g of catalyst) and reduced at 350° C. in stream of 10% hydrogen gas in Nitrogen (1 l/h·g of catalyst) for 3 h to obtain the 1% Pt/β-SiC(PT).

### Example 17

### Preparation of CuFeCrO_{b}/β-SiC(PT) Catalyst

An aqueous solution of chromium anhydride, iron ammonium citrate and copper nitrate were impregnated using the pore volume method or dry impregnation method into the β-SiC(PT). In this method, 6 ml aqueous solution of chromium anhydride, ammonium iron citrate and copper nitrate in the molar ratio of 1:1:1 (stoichiometric proportional) were added to 10 g of β-SiC(PT) and then the solid was left to mature for 12 hours. The solid was then oven dried at 120° C. for twelve hours, and calcined for 5 hours at 900° C. in a stream of dry air (1 l/h·g of catalyst) to obtain the CuFeCrO_{b}/β-SiC(PT) in which elemental ratio of Cu:Fe:Cr was found to be 1:1:1.

### Example 18

### Preparation of CuFeCrO_{c}/β-SiC(PT) Catalyst

An aqueous solution of copper nitrate, iron ammonium citrate and chromium anhydride were impregnated using the pore volume method or dry impregnation method into the β-SiC(PT). In this method, 6 ml aqueous solution of copper nitrate, iron ammonium citrate and chromium anhydride in the molar ratio of 1:1:4 (stoichiometric proportional) were added to 10 g of β-SiC(PT) and then the solid was left to mature for 12 hours. The solid was then oven dried at 120° C. for twelve hours, and calcined for 5 hours at 900° C. in a stream of dry air (1 l/h·g of catalyst) to obtain the CuFeCrO_{b}/β-SiC(PT) in which elemental ratio of Cu:Fe:Cr was found to be 1:1:4.

### Example 19 (Activity Test of the Prepared Catalysts)

Method 1: Catalyst obtained from the above examples 1 to 6 are tested in a fixed bed reactor as mentioned below. 1 g of catalyst is loaded into the middle of the glass tube reactor and preheated N₂ inert gas along with the liquid H₂SO₄ (98 wt %) along with N₂ inert gas was pumped through a syringe pump to the primary decomposer, where the temperature was maintained at 973 K. The space velocity of sulfuric acid is maintained between 500 ml/g. catalyst-hr and 50,000 ml/g catalyst-hr. The reactor temperature is kept between 1000 K and 1223 K and pressure is kept at atmospheric pressure. For high pressure experiments (i.e. pressure between 1 to 20 bar) Hastelloy reactor is was used. The decomposed products (traces of H₂SO₄, SO₃, H₂O, SO₂ and O₂) over the catalyst were passed through a series of absorbers where all gases are absorbed for quantitative analysis except N₂ and O₂. The unabsorbed oxygen gas is quantified using gas chromatograph and oxygen analyzer.

Method 2: Catalyst obtained from the above examples 1 to 6 are tested in a dual stage fixed bed reactor. In a typical experiment, liquid sulfuric acid at room temperature is fed to the first stage decomposer by means of a syringe pump at defined flow rate along with inert carrier gas nitrogen through mass flow controller (MFC). The 1^{st} stage is maintained at 973 K throughout the experiment to ensure complete decomposition of sulfuric acid. Thermally decomposed SO₃, H₂O and N₂ flows through hot ceramic beads which act as a preheating section before reaching the catalyst bed in the 2^{nd} stage reactor. The catalytically decomposed products (SO₂, O₂, H₂O, N₂ and un-decomposed SO₃) were cooled and are trapped in two bottles connected in series, which are filled with I₂/I⁻ aqueous solution to measure the concentration of SO₃ and SO₂. Unabsorbed gases are analyzed in agas chromatograph (NUCON, Model 5765, equipped with TCD andGC column packed with carbosphere) and an online oxygen analyzer.

TABLE 1
Activity test of various supported catalysts
in sulphuric acid decomposition reaction.

| | | % of conversion (decomposition) | | | | |
|---|---|---|---|---|---|---|
| Example | Catalyst | 1023 | 1073 | 1123 | 1173 | 1223 |
| 1(a) | β-SiC(R) | 8.8 | 11.8 | 30.1 | 35.4 | 56.3 |
| | β-SiC(P) | 7.6 | 12 | 28.8 | 35.0 | 56.9 |
| | β-SiC(PT) | 9 | 12 | 30 | 36 | 57.1 |
| 1(b) | Fe₂O₃/β-SiC(R) | 18.1 | 29.4 | 68.3 | 79.2 | 87.6 |
| 1(c) | Fe₂O₃/β-SiC(P) | 17.2 | 28.1 | 65.9 | 78.5 | 82.1 |
| 1(d) | Fe₂O₃/β-SiC(PT) | 20 | 34 | 72 | 83.0 | 87.6 |
| 2(a) | Cu₂O/β-SiC(R) | 18.4 | 45.2 | 69.6 | 82.3 | 86.7 |
| 2(b) | Cu₂O/β-SiC(PT) | 21 | 49 | 73.5 | 84.2 | 88.5 |
| 3(b) | Cr₂O₃/β-SiC(PT) | 19.5 | 48.3 | 74.1 | 84.0 | 88.1 |
| 4(a) | CuFe₂O₄/β-SiC(R) | 19.3 | 46.2 | 71.4 | 82.7 | 84.8 |
| 4(b) | CuFe₂O₄/β-SiC(P) | 18.7 | 45.1 | 70.9 | 80.6 | 82.1 |
| 4(c) | CuFe₂O₄/β-SiC(PT) | 23 | 52 | 74.7 | 88.5 | 91.0 |
| 5(a) | CuCr₂O₄/β-SiC(R) | 20.9 | 53.2 | 71.6 | 86.2 | 88.9 |
| 5(b) | CuCr₂O₄/β-SiC(PT) | 23.5 | 55 | 76.5 | 89 | 92.6 |
| 6(a) | FeCr₂O₄/β-SiC(R) | 20.6 | 53.2 | 74.2 | 85.3 | 88.6 |
| 6(b) | FeCr₂O₄/β-SiC(PT) | 22.5 | 54 | 77 | 88 | 91.9 |
| 7 | CuFe₂O₄/Al₂O₃ | 15.2 | 38.0 | 60.5 | 71.1 | 86.0 |
| 8 | Fe₂O₃/Al₂O₃ | 16.0 | 36.5 | 57 | 68.5 | 83.2 |
| 9(a) | CoFe₂O₄ | 15.4 | 22.3 | 58.9 | 67.7 | 77.3 |
| 9(b) | CoFe₂O₄/β-SiC(PT) | 18.4 | 24.8 | 62.7 | 75.4 | 80.8 |
| 10(a) | NiFe₂O₄ | 14.9 | 20.5 | 48.1 | 54.4 | 58.4 |
| 10(b) | NiFe₂O₄/β-SiC(PT) | 14.2 | 20.4 | 48.2 | 58.9 | 62.5 |
| 11(a) | ZnFe₂O₄ | 18.2 | 32.9 | 61.3 | 68.7 | 72.1 |
| 11(b) | ZnFe₂O₄/β-SiC(PT) | 19.1 | 33.4 | 64.2 | 71.1 | 73.7 |
| 12(a) | NiCr₂O₄ | 20.2 | 30.1 | 69.2 | 75.6 | 82.1 |
| 12(b) | NiCr₂O₄/β-SiC(PT) | 20.8 | 32.2 | 71.8 | 78.1 | 84.9 |
| 13(a) | ZnCr₂O₄ | 19.2 | 29.5 | 55.3 | 66.0 | 72.8 |
| 13(b) | ZnCr₂O₄/β-SiC(PT) | 19.6 | 32.7 | 58.5 | 68.6 | 76.8 |
| 14 | Cr₂O₃ | 18.3 | 45.1 | 71.2 | 80.1 | 84.2 |
| 15 | Cu₂O | 16.9 | 42.1 | 69.3 | 78.9 | 83.7 |
| 16(a) | 1% Pt/Al₂O₃ | 64.2 | 73.8 | 81.1 | 87.2 | 91.7 |
| 16(b) | 1% Pt/β-SiC(PT) | 67.1 | 76.2 | 83.2 | 88.1 | 92.5 |
| 17 | CuFeCrO_{b}/β-SiC(PT) | 18.1 | 43.2 | 67.8 | 81.2 | 85.4 |
| | (Cu/Fe/Cr = 1:1:1) | | | | | |
| 18 | CuFeCrO_{b}/β-SiC(PT) | 19.0 | 47.1 | 70.8 | 82.3 | 86.2 |
| | (Cu/Fe/Cr = 1:1:4) | | | | | |
| 19 | Equilibrium | 69.5 | 78.8 | 85.4 | 90.1 | 93.1 |

TABLE 2
Catalyst stability test of most active catalysts

| Example | Time in (h) | 0 | 10 | 25 | 50 | 100 | 200 | 300 |
|---|---|---|---|---|---|---|---|---|
| 1(b) | Fe₂O₃/β-SiC(R) | 69.5 | 67.3 | 62.2 | 55.2 | * | * | * |
| 1(d) | Fe₂O₃/β-SiC(PT) | 73.1 | 73.0 | 72.2 | 71.5 | 71.2 | 70.0 | 69.2 |
| 2(a) | Cu₂O/β-SiC(R) | 71.2 | 68.5 | 61.7 | * | * | * | * |
| 2(b) | Cu₂O/β-SiC(PT) | 75.3 | 74.1 | 73.4 | 72.1 | 71.2 | 70.4 | 68.6 |
| 3(a) | Cr₂O₃/β-SiC(R) | 74.8 | 70.3 | 66.7 | | | | |
| 3(b) | Cr₂O₃/β-SiC(PT) | 76 | 73 | 71 | 65.3 | | | |
| 4(a) | CuFe₂O₄/β-SiC(R) | 75.2 | 70.8 | 68.3 | 64.7 | | | |
| 4(c) | CuFe₂O₄/β-SiC(PT) | 76.5 | 76.3 | 75.4 | 74.2 | 73.0 | 72.4 | 71.3 |
| 5(a) | CuCr₂O₄/β-SiC(R) | 75.6 | 73.1 | 72.3 | 68.7 | | | |
| 5(b) | CuCr₂O₄/β-SiC(PT) | 78.3 | 76.4 | 73.4 | 68.1 | | | |
| 6 | FeCr₂O₄/β-SiC(PT) | 78.1 | 76.8 | 74.3 | 66.2 | | | |
| 7 | CuFe₂O₄/Al₂O₃ | 60 | 51 | 42 | | | | |
| 8 | Fe₂O₃/Al₂O₃ | 55 | 44 | 29 | | | | |

Iron(III) oxide was loaded on three different surface treated β-SiC as shown in the Table 1, example 1(b), 1(c) and 1(d). The catalyst activity was measured in a fixed bed reactor at various temperatures. It was clear that the catalyst prepared from the pre-treated support gives the highest conversion as compared to the as-received or pure silicon carbide. This high activity is attributed to the high dispersion of Iron (III) oxide on the support enriched with SiO₂. Similarly, among all the catalysts, Examples 4(c), Example 5 and Example 6 have shown highest activity over the temperature range considered, which again possess pre-treated or silicated β-SiC support. Although, these pre-treated support catalyst shows marginal high conversion as compared to the catalyst prepared by as-received catalyst support, but the stability of the catalyst surprisingly increased with silicated catalyst support of porous β-SiC. The stability of various catalysts were tested over a period of 10 to 300 h and are shown in Table 2. It appears that the catalyst supported on pre-treated silicon carbide was much more active, stable than the catalyst supported on as-received SiC or other supports. During the first 25 hours of the test, catalyst with all kind of β-SiC supports exhibited similar activity for the decomposition of sulfuric acid, while catalyst whose supports are pre-treated, Examples 4(c), 2(b) and 1(d) i.e. Catalyst CuFe₂O₄/β-SiC(PT), Cu₂O/β-SiC(PT), and Fe₂O₃/β-SiC(PT) have retained their activity up to 300 h of operation.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever. The preceding examples can be repeated with similar success by substituting the generically or specifically described reactants and/or operating conditions of this invention for those used in the preceding examples. From the foregoing description, one skilled in the art can easily ascertain the essential characteristics of this invention and, without departing from the spirit and scope thereof, can make various changes and modifications of the invention to adapt it to various usages and conditions.

Although the subject matter has been described in considerable detail with reference to certain embodiments thereof, other embodiments are possible.

### REFERENCES

[1] Dokiya M, Kameyama T, Fukuda K, Kotera Y. The study of thermochemical hydrogen preparation. III. An oxygen-evolving step through the thermal splitting of sulfuric acid. Bull Chem Soc Jpn 1977; 50:2657-60.
[2] Norman J, Mysels K, Sharp R, Williamson D. Studies of the sulfur-iodine thermochemical water-splitting cycle. Int J Hydrogen Energy 1982; 7:545-56. doi:10.1016/0360-3199(82)90035-0.
[3] Ishikawa H, Ishii E, Uehara I, Nakane M. Catalyzed thermal decompositon of H2SO4 and production of HBr by the reaction of SO2 with Br2 and H2O. Int J Hydrogen Energy 1982; 7:237-46. doi:10.1016/0360-3199(82)90087-8.
[4] Tagawa H, Endo T. Catalytic decomposition of sulfuric acid using metal oxides as the oxygen generating reaction in thermochemical water splitting process. Int J Hydrogen Energy 1989; 14:11-7. doi:10.1016/0360-3199(89)90151-1.
[5] Barbarossa V, Brutti S, Diamanti M, Sau S, De Maria G. Catalytic thermal decomposition of sulphuric acid in sulphur-iodine cycle for hydrogen production. Int J Hydrogen Energy 2006; 31:883-90. doi:10.1016/j.ijhydene.2005.08.003.
[6] Kim T, Gong G, Gwon B, Lee K-Y, Jeon H-Y, Shin C-H, et al. Catalytic decomposition of sulfur trioxide on the binary metal oxide catalysts of Fe/Al and Fe/Ti. Appl Catal A Gen 2006; 305:39-45. doi:10.1016/j.apcata.2006.02.052.
[7] Banejee A, Pai M, Bhattacharya K, Tripathi A, Kamble V, Bharadwaj S, et al. Catalytic decomposition of sulfuric acid on mixed Cr/Fe oxide samples and its application in sulfur-iodine cycle for hydrogen production. Int J Hydrogen Energy 2008; 33:319-26. doi:10.1016/j.ijhydene.2007.07.017.
[8] Ginosar D M, Petkovic L M, Glenn A W, Burch K C. Stability of supported platinum sulfuric acid decomposition catalysts for use in thermochemical water splitting cycles. Int J Hydrogen Energy 2007; 32:482-8. doi:10.1016/j.ijhydene.2006.06.053.
[9] Abimanyu H, Jung K-D, Jun K-W, Kim J, Yoo K S. Preparation and characterization of Fe/Cu/Al₂O₃-composite granules for SO3 decomposition to assist hydrogen production. Appl Catal A Gen 2008; 343:134-41. doi:10.1016/j.apcata.2008.03.033.
[10] Mallanna B, Kwang N ÆE, Jung D. Synthesis of Cu/Fe/Ti/Al2O3 Composite Granules for SO3 Decomposition in SI Cycle. Ratio 2009:248-52. doi:10.1007/s10562-008-9747-3.
[11] Karagiannakis G, Agrafiotis C C, Zygogianni A, Pagkoura C, Konstandopoulos A G. Hydrogen production via sulfur-based thermochemical cycles: Part 1: Synthesis and evaluation of metal oxide-based candidate catalyst powders for the sulfuric acid decomposition step. Int J Hydrogen Energy 2010:1-14. doi:10.1016/j.ijhydene.2010.11.083.
[12] Banerjee A M, Pai M R, Meena S S, Tripathi A K, Bharadwaj S R. Catalytic activities of cobalt, nickel and copper ferrospinels for sulfuric acid decomposition: The high temperature step in the sulfur based thermochemical water splitting cycles. Int J Hydrogen Energy 2011; 36:4768-80. doi:10.1016/j.ijhydene.2011.01.073.
[13] Zhang P, Su T, Chen Q H, Wang L J, Chen S Z, Xu J M. Catalytic decomposition of sulfuric acid on composite oxides and Pt/SiC. Int J Hydrogen Energy 2012; 37:760-4. doi:10.1016/j.ijhydene.2011.04.064.
[14] Karagiannakis G, Agrafiotis C C, Zygogianni A, Pagkoura C, Konstandopoulos A G. Hydrogen production via sulfur-based thermochemical cycles: Part 1: Synthesis and evaluation of metal oxide-based candidate catalyst powders for the sulfuric acid decomposition step. Int J Hydrogen Energy 2011; 36:2831-44. doi:10.1016/j.ijhydene.2010.11.083.
[15] Giaconia A, Sau S, Felici C, Tarquini P, Karagiannakis G, Pagkoura C, et al. Hydrogen production via sulfur-based thermochemical cycles: Part 2: Performance evaluation of Fe₂O₃-based catalysts for the sulfuric acid decomposition step. Int J Hydrogen Energy 2011; 36:6496-509. doi:10.1016/j.ijhydene.2011.02.137.
[16] Lee S Y, Jung H, Kim W J, Shul Y G, Jung K-D. Sulfuric acid decomposition on Pt/SiC-coated-alumina catalysts for SI cycle hydrogen production. Int J Hydrogen Energy 2013; 38:6205-9. doi:10.1016/j.ijhydene.2013.01.107.
[17] Dominique Dubots L F. Binodal Metallic Carbide and Its use as a Catalyst. U.S. Pat. No. 5,217,930, 1993.
[18] Doninique Dubots L F. United States Patent 1191. U.S. Pat. No. 5,460,759, n.d.
[19] Grindatto B, Jourdan A, Prin M. Process for the production of metal carbides having a large specific surface under atmospheric pressure inert gas scavenging. U.S. Pat. No. 5,427,761, n.d.
[20] Baluais G, Ollivier B. Catalyst Support with Base of Silicon Carbide with High Specific Surface Area in Granulated form having improved mechanical characteristics. 6184178b1, 2001.

1. A catalyst composition for conversion of sulphur trioxide to sulphur dioxide and oxygen comprising:
an active material selected from the group consisting of transitional metal oxide, mixed transitional metal oxide, and combinations thereof; and
a support material selected from the group consisting of silica, titania, zirconia, carbides, and combinations thereof, wherein the active material to the support material weight ratio is in the range of 0.1 to 25 wt %.

2. The catalyst composition as claimed in claim 1, wherein the transitional metal is selected from the group consisting of Cu, Cr, and Fe.

3. The catalyst composition as claimed in claim 1, wherein the active material is transitional metal oxide selected from the group consisting oxides of Cu, Cr, and Fe.

4. The catalyst composition as claimed in claim 1, wherein the active material is mixed transitional metal oxide selected from the group consisting of binary oxide, a ternary oxide, and a spinel.

5. The catalyst composition as claimed in claim 1, wherein the active material is an oxide of Cu.

6. The catalyst composition as claimed in claim 1, wherein the active material is an oxide of Cr.

7. The catalyst composition as claimed in claim 1, wherein the active material is an oxide of Fe.

8. The catalyst composition as claimed in claim 1, wherein the active material is a binary oxide of Cu, and Fe in the molar ratio of 1:2.

9. The catalyst composition as claimed in claim 1, wherein the active material is an oxide of Cu, and Fe with a spinel structure.

10. The catalyst composition as claimed in claim 1, wherein the active material is an oxide of Cu, and Cr with a spinel structure.

11. The catalyst composition as claimed in claim 1, wherein the support material has a pore volume in the range of 0.05 to 0.9 cc/g, preferably 0.4 to 0.9 cc/g.

12. The catalyst composition as claimed in claim 1, wherein the support material has active surface area in the range of 5-35 m²/g, specific surface area as determined by BET multipoint nitrogen absorption method is in the range of 2 to 200 m²/g, transitional metal content in the catalyst composition is in the range of 0.1 to 20 wt %.

13. The catalyst composition as claimed in claim 1, wherein the support material is crystallized porous β-SiC.

14. The catalyst composition as claimed in claim 1, wherein the catalyst composition is used for decomposition of sulphuric acid.

15. The catalyst composition as claimed in claim 1, wherein the catalyst composition is used for hydrogen production.

16. A process for producing a catalyst composition as claimed in claim 1, the process comprising;
contacting at least one transitional metal salt with a support material selected from the group consisting of silica, titania, zirconia, carbides, and combinations thereof to obtain a transitional metal loaded porous material;
calcining the transitional metal loaded porous material at a temperature range of 250-600° C. for a period of 1 to 6 hours and optionally heating at 900 to 1100° C. for 2 to 5 hours to obtain a catalyst composition comprising an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

17. The process as claimed in claim 16, wherein the support material is contacted with an aqueous solution of the at least one transitional metal salt and homogenized to obtain transitional metal loaded porous material.

18. The process as claimed in claim 16, wherein the support material is contacted with an aqueous solution of the at least one transitional metal salt in parts and homogenized by sonication to obtain transitional metal loaded porous material.

19. The process as claimed in claim 16, wherein the support material is contacted with an aqueous solution of the at least one transitional metal salt, homogenized by sonication for 10 minutes to 1 hour, and dried at 50-150° C. for 10 minutes to 5 hours to obtain transitional metal loaded porous material.

20. The process as claimed in claim 16, wherein the transitional metal loaded porous material is air dried at 50-150° C. for 10 minutes to 5 hours before calcination.

21. A process for producing a catalyst composition as claimed in claim 1, the process comprising;
contacting at least one transitional metal salt with a support material selected from the group consisting of silica, titania, zirconia, carbides, and combinations thereof to obtain a partial transitional metal loaded porous material;
drying the partial transitional metal loaded porous material at 50-150° C. for 10 minutes to 5 hours, contacting at least one transitional metal salt with a partial transitional metal loaded porous material to obtain a transitional metal loaded porous material;
calcining the transitional metal loaded porous material at a temperature range of 250-600° C. for a period of 1 to 6 hours and optionally heating at 900 to 1100° C. for 2 to 5 hours to obtain a catalyst composition comprising an active material selected from the group consisting of transitional metal oxide, mixed transitional metal oxide, and combinations thereof; and a support material selected from the group consisting of silica, titania, zirconia, carbides, and combinations thereof, wherein the active material to the support material weight ratio is in the range of 0.1 to 25 wt %.

22. The process as claimed in claim 21, wherein the support material is contacted with an aqueous solution of the at least one transitional metal salt and homogenized to obtain partial transitional metal loaded porous material.

23. The process as claimed in claim 21, wherein the partial transitional metal loaded porous material is contacted with an aqueous solution of the at least one transitional metal salt and homogenized to obtain the transitional metal loaded porous material.

24. The process as claimed in claim 21, wherein the support material is contacted with an aqueous solution of the at least one transitional metal salt in parts and homogenized by sonication to obtain partial transitional metal loaded porous material.

25. The process as claimed in claim 21, wherein the partial transitional metal loaded porous material is contacted with an aqueous solution of the at least one transitional metal salt in parts and homogenized by sonication to obtain transitional metal loaded porous material.

26. The process as claimed in claim 21, wherein the support material is contacted with an aqueous solution of the at least one transitional metal salt, homogenized by sonication for 10 minutes to 1 hour, and dried at 50-150° C. for 10 minutes to 5 hours to obtain partial transitional metal loaded porous material.

27. The process as claimed in claim 21, wherein the partial transitional metal loaded porous material is contacted with an aqueous solution of the at least one transitional metal salt, homogenized by sonication for 10 minutes to 1 hour, and dried at 50-150° C. for 10 minutes to 5 hours to obtain transitional metal loaded porous material.

28. The process as claimed in claim 21, wherein the transitional metal loaded porous material is dried at 50-150° C. for 10 minutes to 5 hours before calcination.

29. The process as claimed in claim 21, wherein the at least one transitional metal salts are salts of transitional metals selected from the group consisting of Cu, Cr, and Fe. salts of Ni are selected from the group consisting of nickel nitrate, nickel chloride, nickel formate, nickel acetate and nickel carbonate.

30. The process as claimed in claim 21, wherein the at least one transitional metal salts of Cu, Cr, and Fe are selected from the group consisting of citrate, nitrate, chloride, formate, acetate and carbonate.

31. The catalyst composition as claimed in claim 21, wherein the support material has a pore volume in the range of 0.4 to 0.9 cc/g.

32. The catalyst composition as claimed in claim 21, wherein the support material has active surface area in the range of 5-35 m²/g.

33. The catalyst composition as claimed in claim 21, wherein the support material is porous silicon carbide (SiC), preferably crystallized porous f-SiC.
